(19) United States
(12) Patent Application Publication
(10) Pub. No.: US 2008/0093099 A1
(43) Pub. Date: Apr. 24, 2008

(54) Electrical Box Ring and Method for Manufacturing The Same

(75) Inventor: Ronald D. Webb, Pasadena, CA (US)

Correspondence Address: BANNER & WITCOFF, LTD., TEN SOUTH WACKER DRIVE, SUITE 3000, CHICAGO, IL, 60606, US

(73) Assignee: Alcan International Limited, Montreal (CA)

(21) Appl. No.: 11/873,157

(22) Filed: Oct. 16, 2007

Related U.S. Application Data
(60) Provisional application No. 60/829,602, filed on Oct. 16, 2006.
(60) Provisional application No. 60/914,494, filed on Apr. 27, 2007.

(51) Int. Cl. H02G 3/12

(52) U.S. Cl. 174/53

(57) ABSTRACT

A two-part multiple gang electrical box ring taught for use in an electrical box assembly. The electrical box ring includes a plate portion and a box ring portion having at least one side wall. The plate portion is affixed to the box ring portion by mechanical engaging means so that the side wall of the box ring portion engages the plate portion at substantially 90°. Preferably, the plate portion comprises one or more positioning tabs and one or more slots and the box ring portion comprises one or more fixing tabs extending from the side wall. The plate portion is affixed to the box ring portion when the fixing tabs are inserted into the slots and the positioning tabs and fixing tabs are folded. A method and a kit for producing the two-part electrical box ring is also provided, as well as a kit for producing an electrical box assembly.

### CROSS-REFERENCE TO RELATED APPLICATIONS

This application claims the priority right of Applicant's prior Provisional Application Ser. No. 60/829,602 filed Oct. 16, 2006 and prior Provisional Application Ser. No. 60/914,494 filed Apr. 27, 2007.

### FIELD OF THE INVENTION

The present invention relates to an electrical box ring for use in an electrical box assembly and a method for producing such an electrical box ring.

### BACKGROUND OF THE INVENTION

In supplying power to residential, commercial or industrial buildings a common electrical power distribution system includes a number of electrical box assemblies containing a number of electrical components that are connected to the building's power supply. The electrical box assemblies are mounted to either the floor or walls of the building by means of mounting plates. A typical box assembly can be seen in U.S. Pat. No. 6,188,022, herein incorporated by reference.

Each electrical box assembly further comprises an electrical box ring, also commonly known as a mud ring. A typical electrical box ring has a planar plate portion, which can be mounted to the mounting plate, and a box ring portion extending therefrom. Electrical box rings are generally used to hold one or more electrical devices behind the wall covering of buildings. Such wall coverings can include dry-wall, wall board, paneling or other modular wall panels. Routers are used to cut a right angle opening in the wall covering into which the electrical box is inserted. To ensure a proper fit plaster, also known as mud, or other suitable filler material is filled in around the electrical box ring.

The size of an electrical box ring is determined by the number of electrical devices it will be used to hold. This is commonly described as 1-Gang, 2-Gang, 3-Gang etc., to denote box rings used to hold 1, 2 and 3 electrical devices, respectively. The depth of the box ring can also vary, depending on the depth of the wall into which it is being inserted.

Electrical box rings can be made of plastic or metals, including steel and less commonly aluminum or zinc. Plastic electrical box rings can be made by injection moulding methods well known in the art. Aluminum and zinc electrical box rings can be made by die casting methods, which are also well known in the art. Although limited use of plastic has been seen in recent years, plastic electrical box rings can only be used for very low voltage applications and are not suited for many commercial and industrial uses. Metallic, and in particular steel electrical box rings meet all safety requirements for higher voltage applications and are presently the most commonly used material for electrical box rings.

Electrical box rings are most commonly made by a stamping process that involves stamping a piece of sheet metal, most commonly steel, to form an outline of the desired size and shape of electrical box ring and then folding the stamped sheet into the electrical box ring.

Stamping electrical box rings has been found to be a relatively easy and efficient process. However, in folding the stamped sheet to assemble the electrical box ring, the side walls of the box portion can never be made at right angles to the plate portion and the resulting side walls are typically quite sloped. The sloped side walls result in additional installation steps, since the box rings does not make a perfect fit into the right angle aperture in the wall covering. As a result it becomes necessary to fill in the spaces around the mounted box ring with plaster or other filler material.

It is therefore greatly desirable to develop an electrical box ring that can be inserted directly into a router-cut aperture in a building wall, without the need to additionally apply plaster, mud or other filler material.

### SUMMARY OF THE INVENTION

The present invention thus generally provides a two-part multiple gang electrical box ring for use in an electrical box assembly. The electrical box ring comprises a plate portion defining a first aperture and a box ring portion having at least one side wall defining a second aperture. The first and second apertures are continuous when the plate portion is brought together with the box ring portion.

Furthermore, the side wall of the box ring portion engages the plate portion at substantially 90° and is affixed thereto by mechanical engaging means.

More preferably a two-part multiple gang electrical box ring is provided that includes a plate portion defining a first aperture, comprising one or more positioning tabs extending into the first aperture and one or more slots formed at a meeting point between the plate portion and the positioning tabs and aligned with the first aperture. The box ring portion comprises at least one side wall defining a second aperture that is continuous with the first aperture when the plate portion is brought together with the box ring portion, and one or more fixing tabs extending from said side wall. The plate portion is affixed to the side wall of the box ring portion at a substantially 90° angle when the fixing tabs are inserted into the slots and the positioning tabs and the fixing tabs are folded against the side wall.

In producing the electrical box ring of the present invention a method is generally provided that involves providing a plate portion defining a first aperture and a box ring portion having at least one side wall defining a second aperture. Next, the plate portion is aligned with the box ring portion such that the first aperture is continuous with the second aperture and the plate portion and the side wall meet at a substantially 90° angle and the plate portion is affixed to the box ring portion by mechanical engaging means.

More preferably, the method involves providing a plate portion defining a first aperture, having one or more positioning tabs extending into the first aperture and one or more slots formed at a meeting point between the plate portion and the positioning tabs and aligned with the first aperture and also providing a box ring portion having at least one side wall defining a second aperture and one or more fixing tabs extending from said side wall. The plate portion is then aligned with the box ring portion such that the first aperture is continuous with the second aperture and the plate portion and the side wall meet at a substantially 90° angle. The fixing tabs are inserted into the slots, the positioning tabs are folded against the side wall and the fixing tabs are then also folded against the side wall.

A kit is provided for producing a two-part multiple gang electrical box ring comprising a plate portion defining a first aperture, a box ring portion comprising at least one side wall defining a second aperture and mechanical engaging means.

More preferably, a kit is also provided for producing a two-part multiple gang electrical box ring, which contains a plate portion defining a first aperture, comprising one or more positioning tabs extending into the first aperture and one or more slots formed at a meeting point between the plate portion and the positioning tabs and aligned with the first aperture and a box ring portion comprising at least one side wall defining a second aperture and one or more fixing tabs extending from said side wall.

A kit is further provided for producing an electrical box assembly, comprising an electrical box, a mounting bracket, a two-part multiple gang box ring comprising a plate portion defining a first aperture, a box ring portion having at least one side wall defining a second and mechanical engaging means, and fastening means.

Finally a kit for producing an electrical box assembly is provided that comprises an electrical box, a mounting bracket and a two part multiple gang electrical box ring comprising a plate portion defining a first aperture, comprising one or more positioning tabs extending into the first aperture and one or more slots formed on the positioning tabs formed at a meeting point between the plate portion and the positioning tabs and aligned with the first aperture and a box ring portion having at least one side wall defining a second aperture and comprising one or more fixing tabs extending from said side wall. Fastening means are also provided in the kit.

### BRIEF DESCRIPTION OF THE DRAWINGS

The present invention will now be described in further detail with reference to the following drawings, in which:

FIG. 1 is a perspective view of the parts of a first embodiment of the two-part electrical box ring of the present invention, in an unassembled form;

FIG. 2 is a perspective view of the parts of a second embodiment of the two-part electrical box ring of the present invention, in an unassembled form;

FIG. 3a is a perspective view of a third embodiment of the plate portion of the electrical box ring of the present invention;

FIG. 3b is a perspective view of a fourth embodiment of the plate portion of the electrical box ring of the present invention;

FIG. 4 is a perspective view of the parts of the two-part electrical box ring of the present invention in an assembled form;

FIG. 5 is a cross-sectional view of one embodiment of the electrical box ring of the present invention;

FIG. 6 is a cross-sectional view of another embodiment of the electrical box ring of the present invention;

FIG. 7 is a flow diagram of a first method of the present invention;

FIG. 8 is a flow diagram of a second method of the present invention;

FIG. 9 is a perspective view of the assembled electrical box ring of FIG. 4 and an electrical box attached to a mounting plate;

FIG. 10 is a perspective view of another embodiment of an electrical box ring in assembled form;

FIG. 11 is a perspective view of the parts of one embodiment of an electrical box ring and a mounting plate, in an unassembled form;

FIG. 12 is a perspective view of the parts of another embodiment of an electrical box ring and a mounting plate, in an unassembled form;

FIG. 13 is a perspective view of one embodiment of a mounting plate of an electrical box ring;

FIG. 14 is a perspective view of another embodiment of a mounting plate of an electrical box ring; and

FIG. 15 is a perspective view of a further embodiment of a mounting plate of an electrical box ring.

### DETAIL DESCRIPTION OF THE PREFERRED EMBODIMENTS

The present invention employs a novel two-part electrical box ring that assembles to form an electrical box ring having substantially right-angled side walls. When assembled, this box ring can be made to precisely fit into a router-cut hole in a dry-wall wall panel and eliminates the need for additional filler material to be applied around the box. The electrical box rings of the present invention are multiple gang electrical box rings, meaning they can accommodate one or more electrical devices within them.

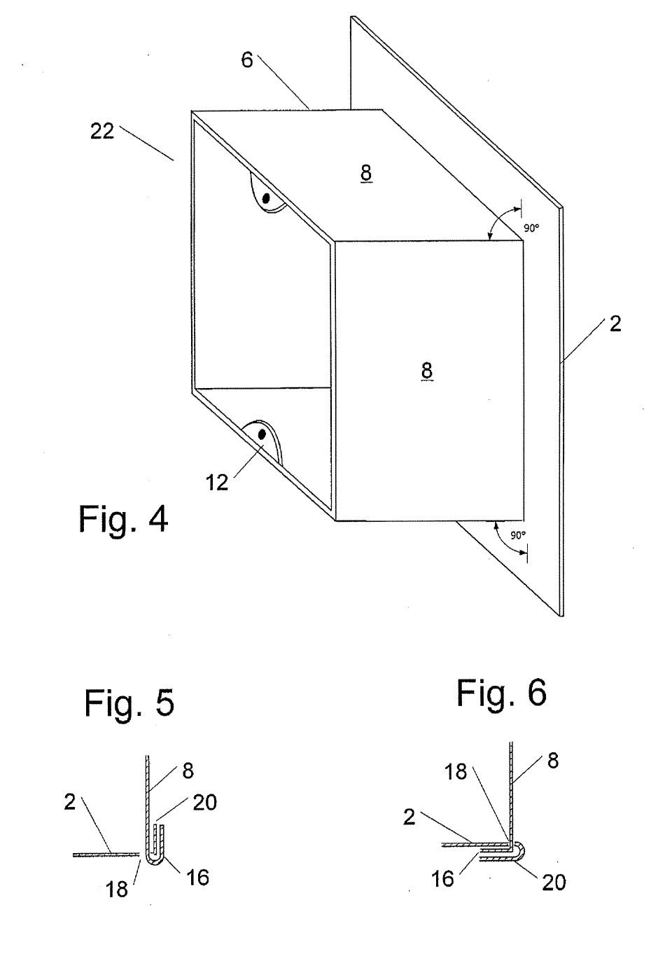

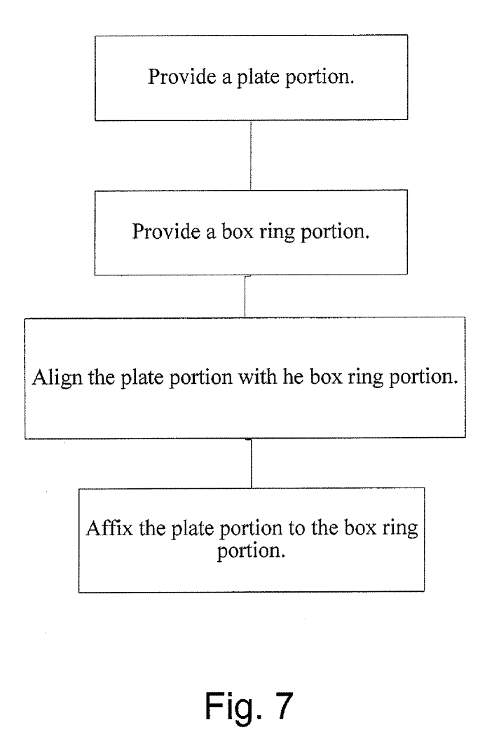

A general illustration of the present box ring is given in FIG. 4. The two stamped portions of the electrical box ring 22 include a plate portion 2 and a box ring portion 6. The box ring portion comprises a stamped sheet metal piece which is then folded to the form of a box having two open ends. The folded box ring portion 6 includes a side wall 8. A flow diagram showing the steps required to assemble this embodiment of the electrical box ring 22 is illustrated in FIG. 7. The electrical box ring 22 is assembled by engaging the plate portion 2 and the side wall 8 of the box ring portion 6 at substantially a 90° angle and then affixing the box ring portion 6 to the plate portion 2 by any known mechanical engaging means. Such mechanical engaging means can include, for example, rivets, screws, such as self-tapping screws, welding, spot welding, latching, brackets, pins or tab-and-slot features. When assembled, the plate portion 2 meets the side wall 8 of the box ring portion at a substantially 90° angle. For the purposes of the present invention, substantially 90° is defined as being any angle between 85° and 95°, more preferably between 87.5° and 92.5°.

In a preferred embodiment, the engaging means are a series of tabs and slots that can be used to affix the plate portion 2 to the box ring portion 6. A tab and slot arrangement is advantageous in that the tabs and slots can be stamped into the two parts of the electrical box ring 22 directly at the stamping stage and therefore, no additional materials or pieces are required. Tabs and slots are also preferred since they have been found to be less cumbersome to assemble than, for example, screws or rivets and provide a cleaner finish than, for example, welding the two parts together. It is desirable to have a clean finish and minimize the number of significant projections of metal parts extending into the inside of the electrical box ring. Such projections have been found to damage the electrical wiring located in the electrical box ring and are thus prohibited by the Underwriter's Laboratory codes.

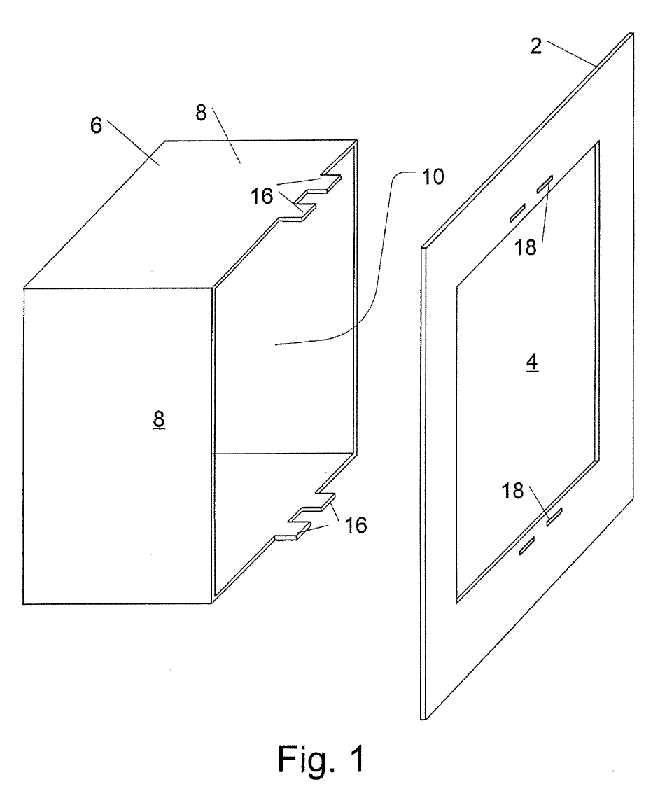

FIG. 1 illustrates a preferred embodiment of the electrical box ring 22 in an unassembled form, showing one preferred embodiment of the tabs and slots. The first part of the electrical box ring 22 is a plate portion 2 having a first aperture 4 formed therein. The second part of the electrical box ring is a box ring portion 6, which comprises one or more side walls 8 that defines a second aperture 10. As seen in FIG. 4, one or more mounting tabs 12 are also optionally formed along one or more edges of the box ring. Holes formed in the mounting tabs can receive any suitable fastener which may be used to fix components within the box or attach cover plates (neither shown). The box ring portion 6 and the plate portion 2 have been illustrated as having a generally square or rectangular shape, however, it must be noted that electrical box rings of the present invention can be of any shape, including circular, hexagonal or octagonal. Very often, electrical box rings are in the shape of a square or rectangle with chamfered corners and this formation is also included in the scope of the shape of the present electrical box ring.

The first aperture 4 is approximately equal in size to the second aperture 10, but can also be nominally smaller or larger, and has an identical shape. In the embodiment of FIG. 1, the side walls 8 of the box ring portion 6 include one or more fixing tabs 16 that extend therefrom. Although two of the side walls 8 in FIG. 1 are shown to have two fixing tabs 16 each, it is to be understood that any number of fixing tabs 16 on any number of the side walls 8 will satisfy the requirements of the present invention and are included in the scope of the invention. The fixing tabs 16 correspond to matching slots 18 formed on the plate portion 2. As with the fixing tabs 16, any numbers of slots 18 along any side of the first aperture 4 are included in the scope of the present invention. In this embodiment, the first aperture 4 is nominally smaller than the second aperture 10.

In assembling the electrical box ring of FIG. 1, the fixing tabs 16 are inserted into the slots 18 and then folded over against either the side wall 8 or the plate portion 2. An assembled electrical box ring 22 is illustrated in FIG. 4, which shows the 90° angle formed between the side walls 8 and the plate portion 2.

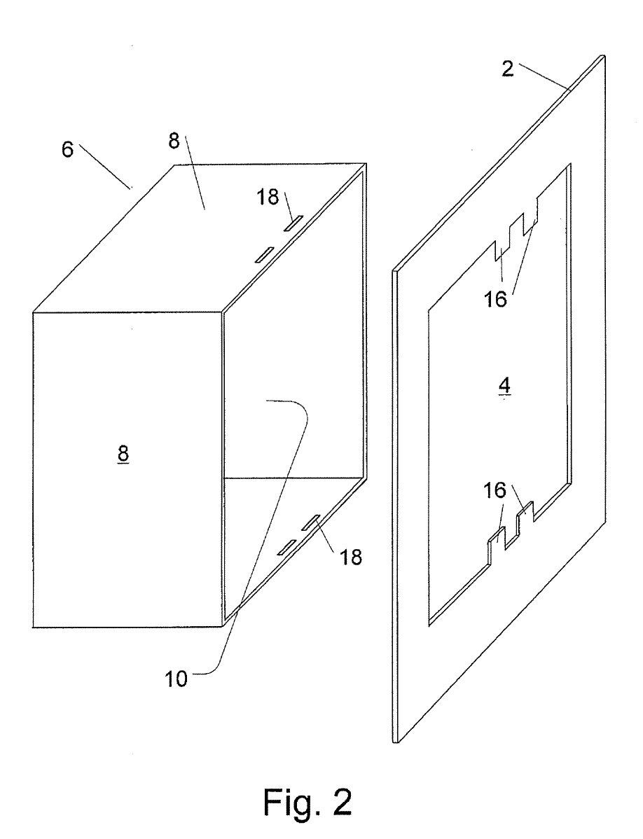

In a second embodiment shown in FIG. 2, one or more fixing tabs 16 can extend from the plate portion 2 into the first aperture 4, and correspond to one or more slots 18 formed in the side walls 8 of the box ring portion 6. In assembling the electrical box ring of this embodiment, the side walls 8 of the box ring portion 6 are slightly compressed into the second aperture 10 as the box ring portion 6 is inserted in the first aperture 4 of the plate portion 2, until the fixing tabs 16 on the plate portion 2 align with the slots 18 in the side wall 8 of the box ring portion 6, at which time the side walls 8 are released to return to their original position and the fixing tabs 16 become inserted into the slots 18. The fixing tabs 16 can then be folded against the side wall 8.

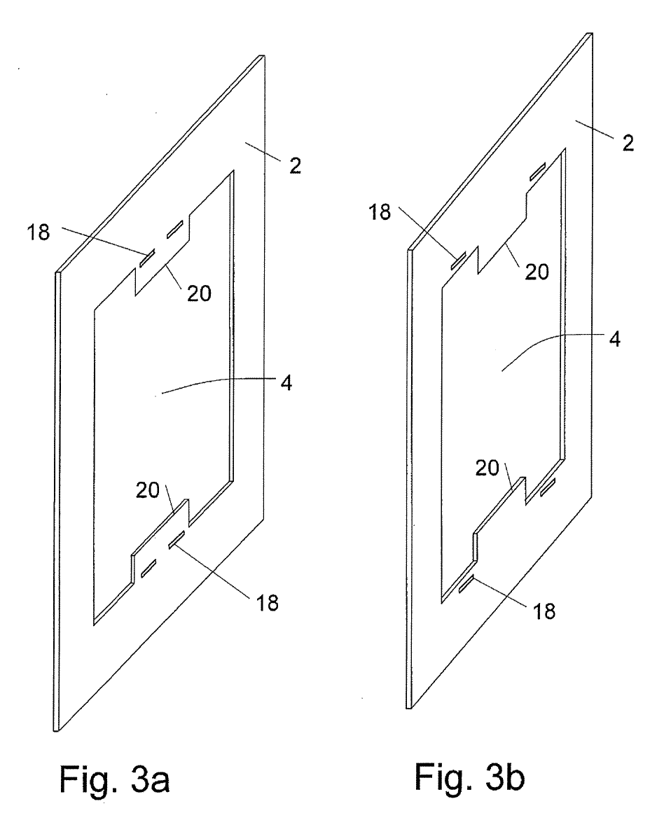

FIGS. 3a and 3b illustrate further preferred embodiments of the plate portion 2, in which one or more positioning tabs 20 extend from the plate portion 2 into the first aperture 4. It is to be understood that any number of positioning tabs 20 on any side of the first aperture 4 are included in the scope of the invention. These positioning tabs 20 are folded during assembly of the electrical box ring 22 to further affix the box ring portion 6 to the plate portion 2. In the embodiment of FIG. 3a, the slots 18 are located a point where the positioning tabs 20 extend from the plate portion 2, in which case the first aperture 4 and the second aperture 10 are equal in size. However, it is also possible for the slots 18 to be placed further back on the plate portion 2, and positioned at any location around the first aperture 4, not necessarily aligned with the positioning tabs 20, as illustrated in FIG. 3b.

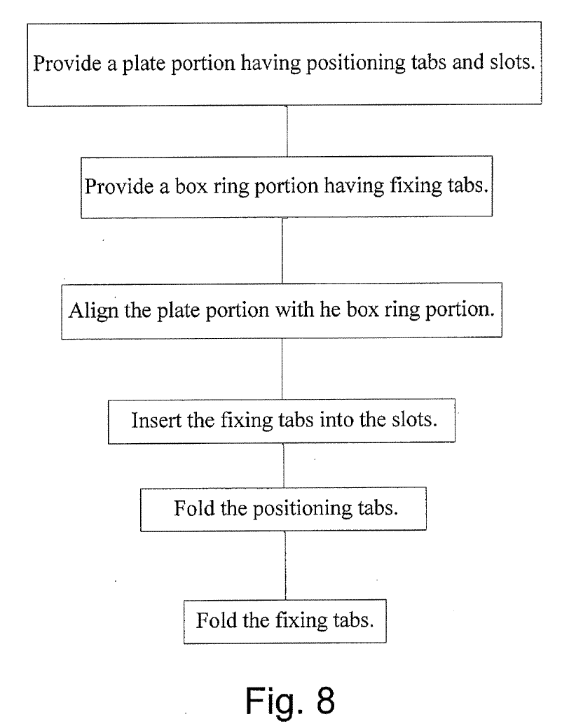

The flow diagram of FIG. 8 illustrates the steps for a preferred method of assembling a box ring 22 using the plate portion of FIG. 3a or FIG. 3b. First, the fixing tabs 16 are inserted into the slots 18, then the positioning tabs 20 are folded over against the side wall 8 and finally the fixing tabs 16 are folded over against the side wall 8. FIG. 5 shows a cross-section of the side wall 8 and plate portion 2 when the box ring 22 is assembled with the positioning tabs 20 and fixing tabs 16 folded against the side wall 8. It should be noted that the folded positioning tabs 20 and fixing tabs 16 add very little extra material to an inside surface of the side wall 8, and form no interfering projections.

In an alternate method for assembling the electrical box ring 22, first the fixing tabs 16 are inserted into the slots 18, then the fixing tabs 16 are folded over against the plate portion 2 and finally the positioning tabs 20 are folded over against the plate portion 2. FIG. 6 illustrates an embodiment of the assembled electrical box ring 22 when the positioning tabs 20 and fixing tabs 16 are folded against the plate portion 2. Again, the folded fixing tabs 20 and the positioning tabs 16 add very little material to the plate portion and cause no interference when the electrical box ring 22 is mounted.

To further facilitate a flush mounting of the electrical box ring 22 to the wall covering, the plate portion 2 of the present invention can optionally be provided with bevelled screw holes (not shown), into which flat head screws can be screwed to a perfectly flat mounting surface and a more exact fit of the electrical box ring 22 into the wall covering.

The two-part multiple gang electrical box ring 22 of the present invention can be provided as a ready to assemble kit containing the plate portion 2 having one or more positioning tabs 20 and one or more slots 18 formed therein, and the box ring portion 6 having one or more fixing tabs 16 formed thereon. The two parts can then be easily assembled by the methods of the present invention, either at a construction site just prior to installation, or a number of kits can be assembled for later installation.

A kit is also provided for an entire electrical box assembly, with the two-part multiple gang electrical box ring 22 of the present invention. The kit includes an electrical box, a mounting bracket and the two-part electrical box ring 22 comprising the plate portion 2 having one or more positioning tabs 20 and one or more slots 18 formed therein and a box ring portion 6 having one or more fixing tabs 16 extending therefrom. Fastening means are also provided in the kit.

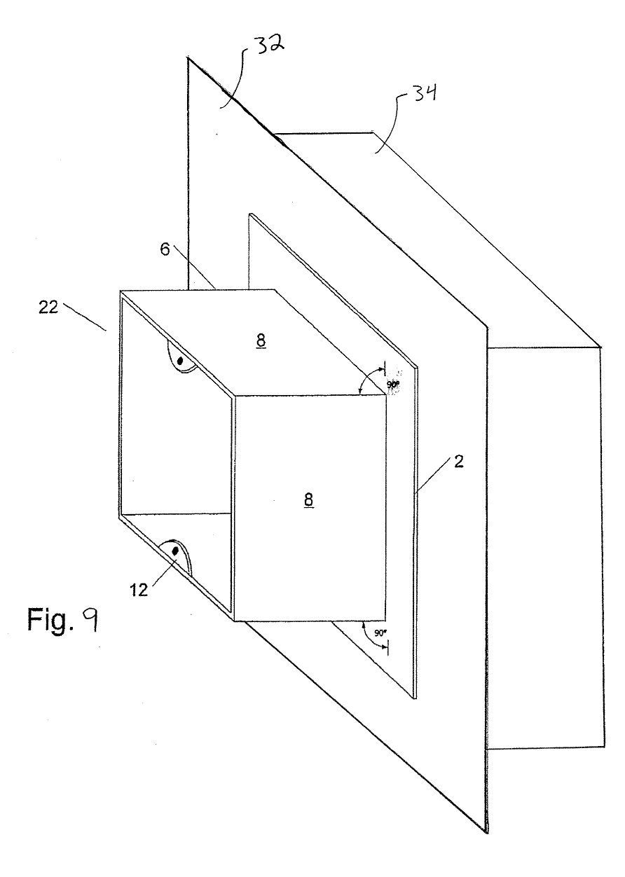

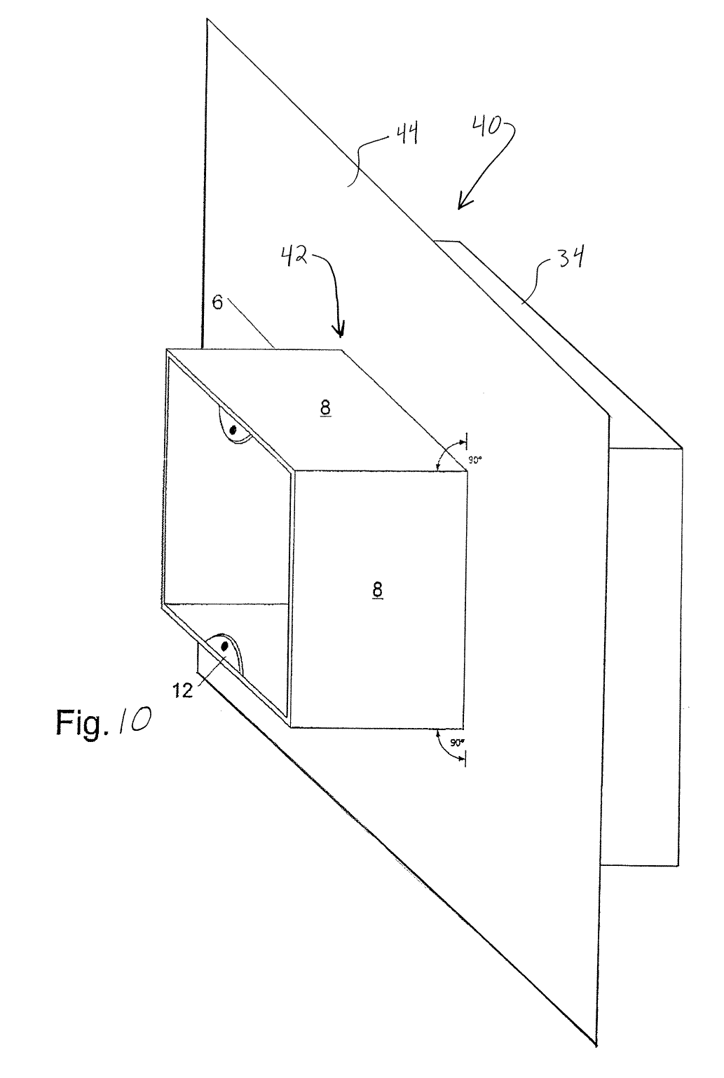

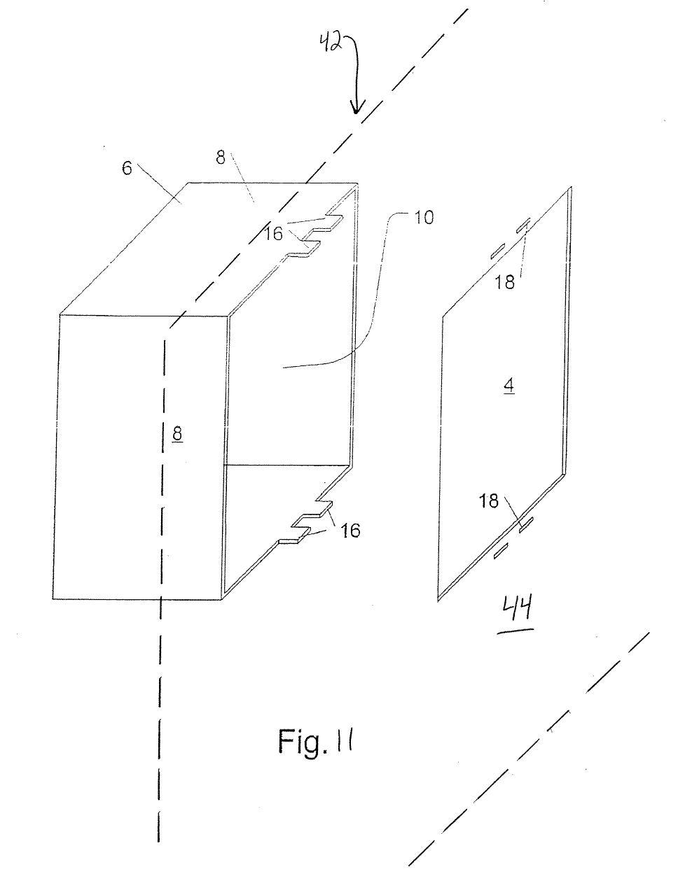

A kit is also provided for an entire electrical box assembly 30, with the electrical box ring 22 of the present invention. FIG. 9 illustrates one embodiment of the assembled electrical box assembly 30. As shown in FIG. 9, the kit includes an electrical box, a mounting bracket or plate 32, and the two-part electrical box ring 22 that includes the plate portion 2 having one or more positioning tabs 20 and one or more slots 18 formed therein and a box ring portion 6 having one or more fixing tabs 16 extending therefrom. The electrical box ring 22 is assembled as described above, and the plate portion 2 is affixed to the mounting plate 32, as shown in FIG. 9. Fastening means are also provided in the kit, for fastening the plate portion 2 to the mounting plate 32. In one embodiment, the fastening means is a plurality of screws, although any known separate or integral fastening means can be used for this purpose. As shown in FIG. 9, the mounting plate 32 may have an electrical box 34 attached thereto, on the surface opposite the electrical box ring 22.

FIGS. 10-15 illustrate components of another embodiment of an electrical box assembly 40. In this embodiment, the assembly 40 has an electrical box ring 42 that contains a ring portion 6 and a plate portion 44 having a first aperture 4 formed therein, as described above. However, in the assembly 40 shown in FIGS. 10-15, the plate portion 2 described above may be embodied in a mounting plate 44, rather than a plate for attachment to a standard mounting plate 32. FIG. 10 illustrates an example of an assembled electrical box assembly 40, where the ring portion 6 is attached directly to a mounting plate 44, without the use of an intermediate portion 2 described above. Such a mounting plate 44 is generally adapted for mounting to a portion of a building or similar structure. For example, the mounting plate 44 may be mounted in a wall, such as by spanning between studs, or may be mounted in any other location where an electrical box is needed, such as in a floor, as known in the art. Although the mounting plates 44 are depicted as a certain size and shape in the Figs., a mounting plate 44 as described herein can have any size and shape necessary for mounting where desired. Similar to the electrical box ring 22 and assembly described above, the electrical box ring 42 can be a multiple gang electrical box ring.

As described above, the box ring portion 6 of the box assembly 40 may, in one embodiment, be constructed from a stamped sheet metal piece which is then folded to the form of a box having two open ends. The folded box ring portion 6 includes one or more side walls 8 that define a second aperture 10. As seen in FIGS. 10-12, one or more mounting tabs 12 are also optionally formed along one or more edges of the box ring portion 6. Holes formed in the mounting tabs can receive any suitable fastener which may be used to fix components within the box or attach cover plates (neither shown).

The plate portion 44 contains mechanical connection features as described above with respect to plate portion 2. The electrical box ring 42 is assembled by engaging the plate portion 44 and the side wall 8 of the box ring portion 6 at substantially a 90° angle and then affixing the box ring portion 6 to the plate portion 44 by mechanical engaging means. Such mechanical engaging means can include, for example, rivets, screws, such as self-tapping screws, welding, spot welding, latching, brackets, pins or tab-and-slot features. When assembled, the plate portion 44 meets the side wall 8 of the box ring portion at a substantially 90° angle. As stated above, for the purposes of the present invention, substantially 90° is defined as being any angle between 85° and 95°.

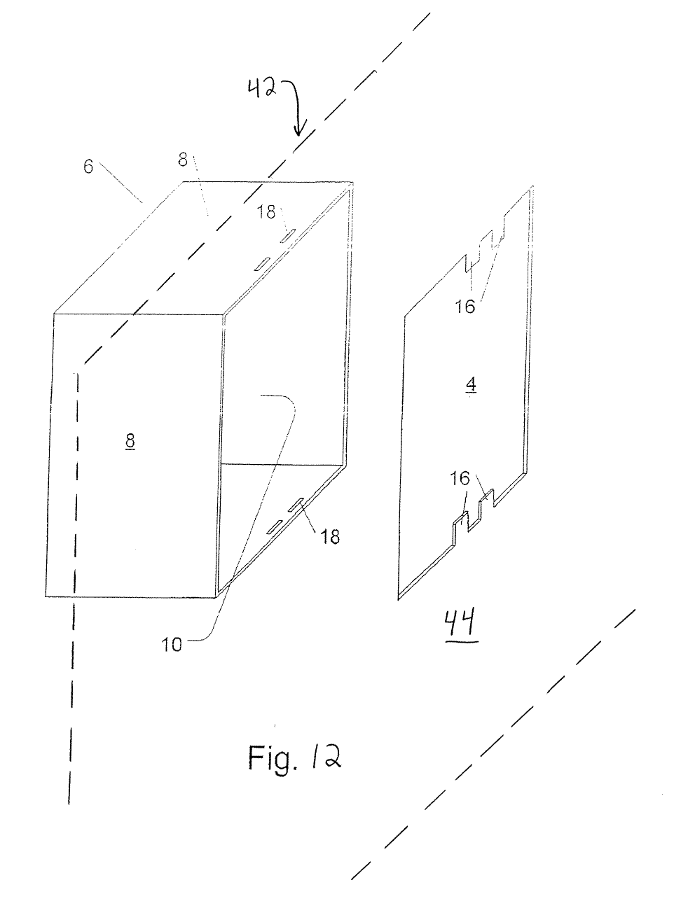

As described above, in the embodiments illustrated in FIGS. 10-15, the mechanical engaging means includes fixing tabs 16 that connect to matching slots 18. In the embodiment shown in FIG. 11, the side walls 8 of the box ring portion 6 include one or more fixing tabs 16 that extend therefrom. Although two of the side walls 8 in FIG. 1 are shown to have two fixing tabs 16 each, it is to be understood that any number of fixing tabs 16 on any number of the side walls 8 will function suitably and are included in the scope of the invention. The fixing tabs 16 correspond to matching slots 18 formed on the plate portion 44. As with the fixing tabs 16, any number of slots 18 along any side of the first aperture 4 are included in the scope of the present invention. In this embodiment, the first aperture 4 is nominally smaller than the second aperture 10.

In assembling the electrical box ring of FIG. 11, the fixing tabs 16 are inserted into the slots 18 and then folded over against either the side wall 8 or the plate portion 44. An assembled electrical box ring 22 is illustrated in FIG. 10, which shows the 90° angle formed between the side walls 8 and the plate portion 44.

In a second exemplary embodiment shown in FIG. 12, one or more fixing tabs 16 can extend from the plate portion 44 into the first aperture 4, and correspond to one or more slots 18 formed in the side walls 8 of the box ring portion 6. In assembling the electrical box ring 42 of this embodiment, the side walls 8 of the box ring portion 6 are slightly compressed into the second aperture 10 as the box ring portion 6 is inserted in the first aperture 4 of the plate portion 44, until the fixing tabs 16 on the plate portion 44 align with the slots 18 in the side wall 8 of the box ring portion 6, at which time the side walls 8 are released to return to their original position and the fixing tabs 16 become inserted into the slots 18. The fixing tabs 16 can then be folded against the side wall 8.

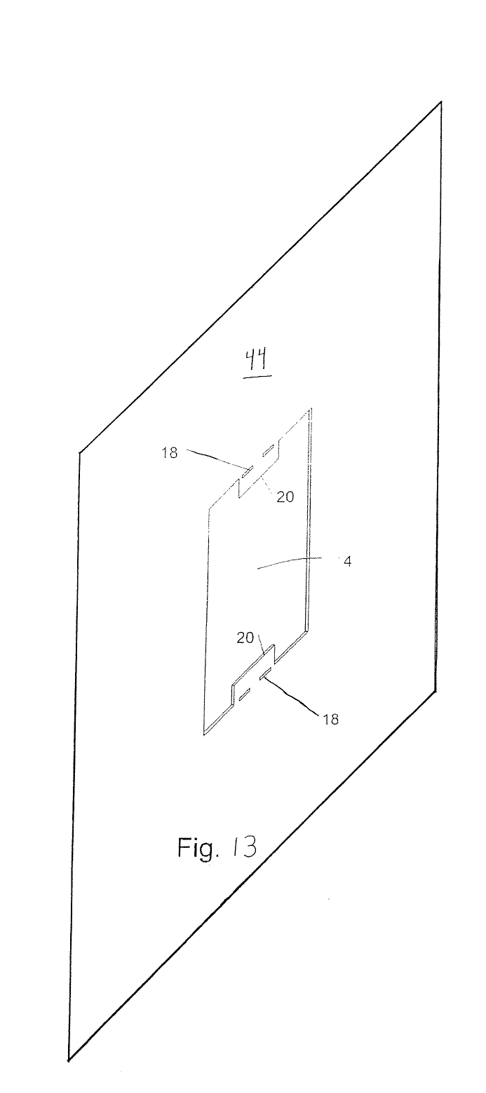

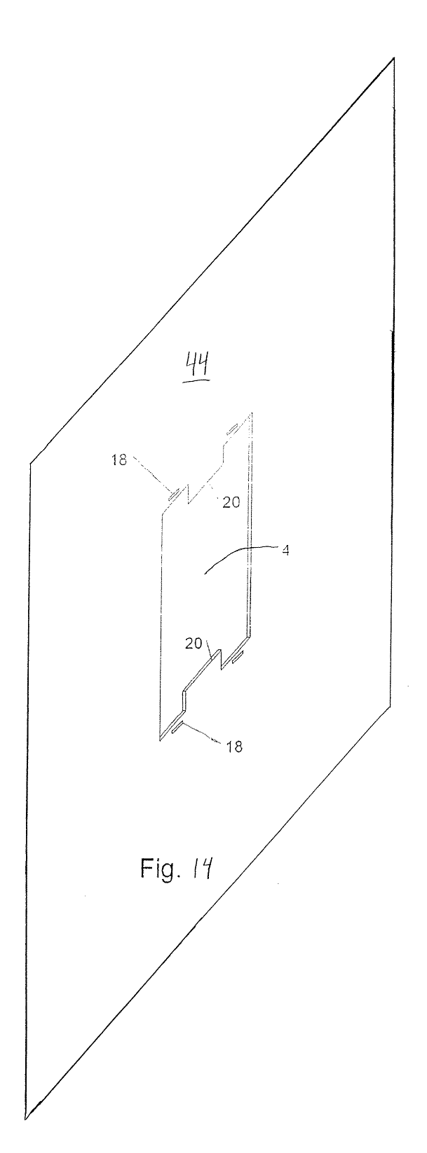

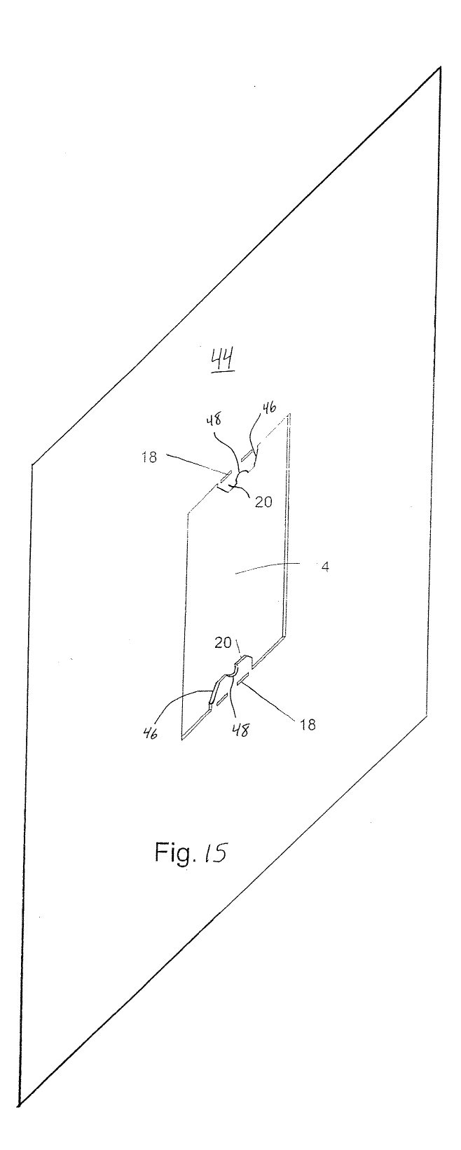

FIGS. 13-15 illustrate additional embodiments of the plate portion 44, in which one or more positioning tabs 20 extend from the plate portion 2 into the first aperture 4. It is to be understood that any number of positioning tabs 20 on any side of the first aperture 4 are included in the scope of the invention. These positioning tabs 20 are folded during assembly of the electrical box ring 42 to further affix the box ring portion 6 to the plate portion 44. In the embodiment of FIG. 13, the slots 18 are located a point where the positioning tabs 20 extend from the plate portion 44, in which case the first aperture 4 and the second aperture 10 are approximately equal in size. The embodiment of FIG. 14 contains positioning tabs 20 similar to those shown in FIG. 13. However, in FIG. 14, the slots 18 are placed further back on the plate portion 44 and are not aligned with the positioning tabs 20. The embodiment of FIG. 15 has slots positioned in alignment with the positioning tabs 20, similarly to the embodiment shown in FIG. 13. However, in FIG. 15, the positioning tabs 20 have beveled or tapered edges 46 and cut-out portions 48, rather than being rectangular. In further embodiments, the slots 18 may be positioned at any location around the first aperture 4, not necessarily aligned with the positioning tabs 20, and the positioning tabs 20 may be positioned and/or shaped in any suitable way.

The electrical box assembly 40 can be assembled in a manner similar to that described above. For example, as already described, the box ring assemblies 40 shown in FIGS. 11 and 12 can be assembled by inserting the fixing tabs 16 into the slots 18, and then bending or folding the tabs 16 to secure the box ring portion 6 to the plate portion 44.

In another example, the exemplary method illustrated in FIG. 8 can be used to assemble the box assembly 40 using the plate portion 44 of FIG. 13, 14, or 15. First, the fixing tabs 16 are inserted into the slots 18, then the positioning tabs 20 are folded over against the side wall 8. Finally the fixing tabs 16 are folded over against the side wall 8. This method may create an assembly having a cross-section similar to the cross-section of the assembled box ring 22 shown in FIG. 5, which shows the side wall 8 and plate portion 2 with the positioning tabs 20 and fixing tabs 16 folded against the side wall 8. It should be noted that the folded positioning tabs 20 and fixing tabs 16 add very little extra material to an inside surface of the side wall 8, and form no interfering projections.

In another method for assembling the electrical box assembly 40 using the plate portion 44 of FIG. 13, 14, or 15, first the fixing tabs 16 are inserted into the slots 18. Next, the fixing tabs 16 are folded over against the plate portion 44. Finally the positioning tabs 20 are folded over against the plate portion 44. This method may create an assembly having a cross-section similar to the cross-section of the assembled box ring 22 shown in FIG. 6, which illustrates the positioning tabs 20 and fixing tabs 16 being folded against the plate portion 2. Again, the folded fixing tabs 20 and the positioning tabs 16 add very little material to the plate portion and cause no interference when the electrical box ring 22 is mounted.

As shown in FIG. 10, the assembly 40 may have an electrical box 34 attached to the mounting plate 44, on the surface opposite the box ring portion 6. This electrical box 34 can be attached to the mounting plate 44 by mechanical engaging means, as described above, including by using a tab and slot arrangement. Thus, the method of assembly described above may also include attaching an electrical box 34 to the plate portion 44 using mechanical engaging means.

The electrical box assembly 40 may be provided as a kit, in either assembled or unassembled format. The assembled kit generally includes the electrical box ring 42, which includes the box ring portion 6 and the plate portion 44, configured and assembled in a manner as described above. Further, the kit and assembly 40 may also include an electrical box 34, as described above, attached to the plate portion 44 opposite the box ring portion 6.

This detailed description of the product and methods is used to illustrate one embodiment of the present invention. It will be apparent to those skilled in the art that various modifications can be made in the present product and methods and that various alternative embodiments can be utilized. Therefore, it will be recognized that various modifications can also be made to the applications to which the method and product are applied without departing from the scope of the invention, which is limited only by the appended claims.

1. A two-part multiple gang electrical box ring for use in an electrical box assembly, comprising a plate portion defining a first aperture and a box ring portion having at least one side wall defining a second aperture that is continuous with the first aperture when the plate portion is brought together with the box ring portion, wherein the side wall of the box ring is affixed to the plate portion by mechanical engaging means.

2. The two-part multiple gang electrical box ring of claim 1 wherein the side wall of the box ring engages the plate portion at substantially 90°.

3. The two-part multiple gang electrical box ring of claim 1 wherein the mechanical engaging means comprises one or more slots formed on the plate portion and one or more fixing tabs extending from the side wall of the box ring portion, wherein the fixing tabs are inserted into the slots and folded to affix the plate portion to the box ring portion.

4. The two-part multiple gang electrical box ring of claim 1 wherein the mechanical engaging means comprises one or more slots formed on the side wall of the box portion and one or more fixing tabs extending into the first aperture of the plate portion, wherein the fixing tabs are inserted into the slots and folded to affix the plate portion to the box ring portion.

5. The two-part multiple gang electrical box ring of claim 3 further comprising one or more positioning tabs extending into the first aperture of the plate portion, said positioning tabs being folded to further affix the plate portion to the box ring portion.

6. The two-part multiple gang electrical box ring of claim 5 wherein the slots are formed at a meeting point between the plate portion and the positioning tabs and aligned with the first aperture.

7. The two-part multiple gang electrical box ring of claim 6 wherein plate portion is affixed to the side wall of the box ring portion at a substantially 90° angle when the fixing tabs are inserted into the slots and the positioning tabs and the fixing tabs are folded against the side wall.

8. The two-part multiple gang electrical box ring of claim 6 wherein plate portion is affixed to the side wall of the box ring portion at a substantially 90° angle when the fixing tabs are inserted into the slots and the fixing tabs and the positioning tabs are folded against the plate portion.

9. A two-part multiple gang electrical box ring for use in an electrical box assembly, comprising:
a) a plate portion defining a first aperture, comprising one or more positioning tabs extending into the first aperture and one or more slots formed at a meeting point between the plate portion and the positioning tabs and aligned with the first aperture; and
b) a box ring portion comprising at least one side wall defining a second aperture that is continuous with the first aperture when the plate portion is brought together with the box ring portion, and one or more fixing tabs extending from said side wall;
wherein the plate portion is affixed to the side wall of the box ring portion at a substantially 90° angle when the fixing tabs are inserted into the slots and the positioning tabs and the fixing tabs are folded against the side wall.

10. A method of producing a two-part multiple gang electrical box ring for use in an electrical box assembly, comprising:
a) providing a plate portion defining a first aperture;
b) providing a box ring portion having at least one side wall defining a second aperture;
c) aligning the plate portion with the box ring portion such that the first aperture is continuous with the second aperture and the plate portion and the side wall meet at a substantially 90° angle; and
d) affixing the plate portion to the box ring portion by mechanical engaging means.

11. The method of claim 10 wherein step d) comprises:
e) providing one or more slots on the side wall of the box ring portion;
f) providing one or more fixing tabs extending into the first aperture of the plate portion;
g) compressing the side walls of the box ring portion towards the second aperture to allow the box ring portion to slide into the first aperture of the plate portion to a point where the slots and fixing tabs are aligned;
h) releasing the side walls of the box ring portion to allow the fixing tabs to fit into the slots; and
i) folding the fixing tabs to affix the plate portion to the box ring portion.

12. The method of claim 10 wherein step d) comprises:
e) providing one or more slots on the plate portion;
f) providing one or more fixing tabs extending from the side wall of the box ring portion;
g) inserting the fixing tabs into the slots; and
h) folding the fixing tabs to affix the plate portion to the box ring portion.

13. The method of claim 12 wherein step e) further comprise providing one or more positioning tabs extending into the first aperture of the plate portion such that the slots are formed at a meeting point between the plate portion and the positioning tabs and step h) comprises folding the positioning tabs against the side wall of the box ring portion and then folding the fixing tabs against the side wall of the box ring portion.

14. The method of claim 12 wherein step e) further comprise providing one or more positioning tabs extending into the first aperture of the plate portion such that the slots are formed at a meeting point between the plate portion and the positioning tabs and step h) comprises folding the fixing tabs against the plate portion and then folding the positioning tabs against the plate portion.

15. A method of producing a two-part multiple gang electrical box ring for use in an electrical box assembly, comprising:
a) providing a plate portion defining a first aperture, having one or more positioning tabs extending into the first aperture and one or more slots formed at a meeting point between the plate portion and the positioning tabs and aligned with the first aperture;
b) providing a box ring portion having at least one side wall defining a second aperture and one or more fixing tabs extending from said side wall;
c) aligning the plate portion with the box ring portion such that the first aperture is continuous with the second aperture and the plate portion and the side wall meet at a substantially 90° angle;
d) inserting the fixing tabs into the slots;
e) folding the positioning tabs against the side wall; and
f) folding the fixing tabs against the side wall.

16. A kit comprising:
a) a plate portion defining a first aperture;
b) a box ring portion comprising at least one side wall defining a second aperture, and
c) mechanical engaging means.

17. The kit of claim 16, wherein the plate portion comprises one or more positioning tabs extending into the first aperture and one or more slots formed at a meeting point between the plate portion and the positioning tabs and aligned with the first aperture and wherein the box ring portion comprises at least one side wall defining a second aperture and one or more fixing tabs extending from said side wall.

18. The kit of claim 16, further comprising:
d) an electrical box;
e) a mounting bracket; and
f) fastening means.
